(19) United States
(12) Patent Application Publication
(10) Pub. No.: US 2018/0352550 A1
(43) Pub. Date: Dec. 6, 2018

(54) METHODS AND ARRANGEMENTS FOR RESOURCE ALLOCATION IN MACHINE TYPE COMMUNICATION DEVICES

(71) Applicant: Telefonaktiebolaget LM Ericsson (publ), Stockholm (SE)

(72) Inventors: Leif Wilhelmsson, Dalby (SE); Naveed Butt, Lund (SE); Yu Wang, Solna (SE)

(73) Assignee: Telefonaktiebolaget LM Ericsson (publ), Stockholm (SE)

(21) Appl. No.: 15/781,106

(22) PCT Filed: Dec. 18, 2015
(86) PCT No.: PCT/EP2015/080656

§ 371 Date: Jun. 1, 2018

(51) Int. Cl. H04W 72/04; H04W 4/70; H04W 76/28; H04W 52/02; H04W 52/14; H04W 52/24; H04W 52/34

(52) U.S. Cl. CPC H04W 72/0453; H04W 4/70; H04W 76/28; H04W 52/346; H04W 52/143; H04W 52/241; H04W 52/0229

(57) ABSTRACT

The disclosure relates to methods, devices, and computer programs in mobile communications. More specifically, the proposed technique relates to resource allocation and in particular to resource allocation for communication with machine type communication devices. This is achieved by a method performed in a wireless device for selecting one or more sub-channels for communication with an access point, wherein the one or more sub-channels is a subset of a plurality of sub-channels supported by the access point, and wherein the access point transmits replicas of a trigger message on the supported sub-channels. The method comprises, on one or more sub-channels of the plurality of sub-channels, attempting to receive a replica of the trigger message, until a trigger message that fulfils at least one predetermined criterion is received, wherein the trigger message indicates the start of a response window. The method comprises to thereafter transmit a response message to the access point in the response window, on the one or more sub-channels on which the trigger message was received.

### TECHNICAL FIELD

The disclosure relates to methods, devices, and computer programs in mobile communications. More specifically, the proposed technique relates to resource allocation and in particular to resource allocation for communication with machine type communication devices.

### BACKGROUND

The 3rd Generation Partnership Project, 3GPP, is responsible for the standardization of the Universal Mobile Telecommunication System, UMTS, and Long Term Evolution, LTE. The 3GPP work on LTE is also referred to as Evolved Universal Terrestrial Access Network, E-UTRAN. LTE is a technology for realizing high-speed packet-based communication that can reach high data rates both in the downlink and in the uplink and is thought of as a next generation mobile communication system relative to UMTS. In order to support high data rates, LTE allows for a system bandwidth of 20 MHz, or up to 100 MHz when carrier aggregation is employed. LTE is also able to operate in different frequency bands and can operate in at least Frequency Division Duplex, FDD, and Time Division Duplex, TDD, modes.

In an UTRAN and an E-UTRAN, a User Equipment, UE, or a wireless device is wirelessly connected to a Radio Base Station, RBS, commonly referred to as a NodeB, NB, in UMTS, and as an evolved NodeB, eNodeB or eNB, in LTE. A Radio Base Station, RBS, or an access point is a general term for a radio network node capable of transmitting radio signals to a UE and receiving signals transmitted by a UE. In Wireless Local Area Network, WLAN, systems the wireless device is also denoted as a Station, STA.

WLAN is a technology that mainly operates in the 2.4 GHz or 5 GHz band. The IEEE 802.11 specifications regulate the physical layer between access points and wireless terminals, Media Access Control, MAC, layer and other aspects to secure compatibility and interoperability between access points and wireless devices, often referred to as stations, STA, when discussing WLAN applications. WLAN is generally operated in unlicensed bands, and as such, communication over WLAN may be subject to interference sources from any number of known and unknown devices. WLAN is commonly used as wireless extensions to fixed broadband access, e.g. in domestic environments and hotspots like airports, train stations and restaurants and the like.

Recently, WLAN has been subject to increased interest from cellular network operators, not only as an extension to fixed broadband access. Instead, the interest is mainly focused on using the WLAN technology as an extension, or alternative to, cellular radio access network technologies. By use of WLAN technology as an extension to cellular radio access network technologies it is contemplated that an ever increasing wireless bandwidth demand may be handled. Cellular operators that currently serve mobile users with, e.g. any of the Third Generation Partnership Project (3GPP) technologies, Long Term Evolution, LTE, Universal Mobile Telecommunications System, UMTS,/Wideband Code Division Multiple Access, WCDMA, or Global System for Mobile communications, GSM, treat WLAN as a technology that may provide good support in their regular cellular networks. The term “operator-controlled WLAN” refers to a WLAN deployment that on some level is integrated with a cellular network operator's existing network and where the 3GPP radio access networks and the WLAN wireless access may even be connected to the same core network and provide the same services.

In 5G, i.e., 5th generation mobile networks, there will be evolvement of the current LTE system to 5G. The main task for 5G is to improve throughput and capacity compared to LTE. This is may in part be achieved by increasing the sample rate and bandwidth per carrier. 5G is also focusing on use of higher carrier frequencies i.e., above 5-10 GHz. One main object of the 5G radio concept is to support Machine Type Communication, MTC, which enables machines to communicate directly with one other, i.e., machine-to-machine, M2M, communication. The M2M communication can be performed in between similar wireless Machine Devices, MDs, or between a wireless device and an access point.

A currently popular vision of the future development of the communication in cellular networks comprises large numbers of small autonomous devices, which typically transmit and receive only small amounts of data irregularly, for instance once per week to once per minute. These devices are generally assumed not to be associated with humans, but are rather sensors or actuators of different kinds, which communicate with application servers for the purpose of configuration of and data receipt from said autonomous devices within or outside the cellular network. The nomenclature used in 3GPP standardization for the communication is Machine Type Communication, MTC, whereas the devices are denoted MTC devices. As these devices are assumed to typically transmit rather seldom, their transmissions will in most cases be preceded by a Random Access, RA, procedure, which establishes the device's access to a network and reveals the device's identity to the network.

M2M can be divided into two main categories with respect to communication requirements. The first category is mission-critical MTC for utilization in real-time control and automation of dynamic processes. The second category is massive MTC, which deals with connectivity for large numbers of low-cost and low-energy devices in the context of the Internet of Things, IoT. The massive M2M communication is the basis in developing the context of the Internet of Things which is expected to become increasingly important in the near future.

Examples of possible M2M applications are almost countless e.g. in private cars for communicating service needs, in water or electricity meters for remote control and/or remote meter reading, in street-side vending machines for communicating when enough coins are present to justify a visit for emptying, in ware houses for indication when goods are out-of-stock, in taxi cars for validating credit cards, in surveillance cameras for home or corporate security purposes, in containers in a transport system etc. Moreover, an M2M device may be mounted at places with severely low accessibility in tough environments where occasions for battery exchanges and re-charging are limited.

Massive MTC is already discussed in standards as 3GPP and IEEE. One type of Massive M2M devices are the once that operates over large ranges with a low power consumption, thus Long Range Low Power, LRLP, operating devices. Standards for LRLP operation in relation to M2M, IoT, energy management, and sensor applications are currently being developed. It is expected that the allocated bandwidth for communication with LRLP devices will be set substantially narrower than what is typically utilized in other wireless devices. Moreover, LRLP devices are usually configured to sleep during long periods of time in order to save power and they only wake up to communicate whenever they have something to report.

In view of the currently developing standards regarding Long Range Low Power operation it is desirable to obtain channel allocation methods that vouch for reliable and high quality communication between an access point and multiple wireless devices.

### SUMMARY

An object of the present disclosure is to provide an access point and wireless devices configured to execute methods and computer programs which seek to mitigate, alleviate, or eliminate one or more of the above-identified deficiencies in the art and disadvantages singly or in any combination.

This object is achieved by a method performed in a wireless device for selecting one or more sub-channels for communication with an access point, wherein the one or more sub-channels is a subset of a plurality of sub-channels supported by the access point, and wherein the access point transmits replicas of a trigger message on the supported sub-channels, wherein the trigger message indicates the start of a response window. The method comprises, on one or more sub-channels of the plurality of sub-channels, attempting to receive a replica of the trigger message and repeating the attempt to receive a replica of the trigger message, until a trigger message that fulfils at least one predetermined criterion is received on one or more sub-channels. The method further comprises, to thereafter, transmit a response message to the access point in the response window, on the one or more sub-channels on which the trigger message was received.

The advantage with the proposed method is that it effectively allows for distributed frequency selective scheduling without explicit sounding. This is especially an advantage when communicating with numerous wireless devices, which might be in sleep mode for long periods of time, i.e., they are not listening to e.g. the beacon from the access point. That is, there is no overhead associated with channel estimation of the sleeping wireless devices. Moreover, the selection made by the wireless devices may be based on a trial-and-error algorithm, rather than on complete measurements over the available sub-channels, i.e., in total fewer channel estimations and measurements may need to be performed.

By utilizing one or a few sub-channels instead of the entire bandwidth, the bandwidth is utilized more efficiently since several wireless devices can communicate with the access point at the same time. Moreover, a better transmission can be achieved when utilizing one or a few sub-channels with a high quality transmission capacity. If instead the entire bandwidth is utilized, parts of the band might have poor transmission capacity, i.e., parts of the signal might be lost.

According to some aspects the method comprises obtaining a channel quality measure of the one or more sub-channels where an attempt to receive is made. Then the trigger message is considered to fulfil the predetermined criterion if the channel quality fulfils a predetermined criterion.

By evaluating the channel quality, it is assured that the sub-channel is only selected if the quality is satisfactory, e.g. for the access point to fulfil demands of further communication, if the selected channel is to be used also for further communication between the wireless device and the access point.

According to some aspects, the method comprises obtaining a channel power measure of the one or more sub-channels where an attempt to receive is made. Then the trigger message is considered to fulfil the predetermined criterion if the channel power fulfils a predetermined criterion. One could of course have as a simple criterion that if the device is able to decode the trigger frame it is considered to fulfil the predetermined criterion and the sub-channel can be used. However, as the transmission power from a sensor device may be substantially lower than the transmission power from an access point, reception of the trigger frame may not be a sufficient condition for that a corresponding transmission from the sensor device will be successful. Therefore, considering the received power can be viewed as a generalization of only requiring the trigger frame to be successfully received.

By evaluating the channel power, it is assured that the sub-channel is not selected if the power is not satisfactory, e.g. for the access point to fulfil demands of further communication, if the selected channel is to be used also for further communication between the wireless device and the access point.

According to some aspects, the received trigger message comprises a transmission power level of the access point and then the predetermined criterion comprises the received transmission power level.

By comparing the received power level with the transmission power level the channel fading is estimated. Hence, the wireless device may avoid selecting a channel with high fading.

According to some aspects, at least one or more of the sub-channels, on which an attempt to receive is made, is randomly selected by the wireless device. As different wireless devices can be assumed to experience uncorrelated channels, the probability of two wireless devices selecting the same sub-channel based on quality measure is as small as if the two wireless devices would select the same sub-channel in a completely random fashion.

According to some aspects, at least one of the sub-channels on which an attempt to receive is made, is selected by applying a predetermined selection rule. It may e.g. be advantageous to select the sub-channel that the radio receiver of the wireless device was making its most recent reception or transmission.

According to some aspects, the response window is a random access window or a scheduled transmission window. This aspect allows for a random access procedure where a large number of wireless devices can be supported taking advantage of the properties of a frequency selective channel.

According to some aspects, the disclosure relates to a computer program comprising computer program code which, when executed in a wireless device, causes the wireless device to execute the method described above and below.

According to some aspects, the disclosure relates to method, performed in an access point for communicating with a wireless device on one or more sub-channels. The method comprises transmitting a replica of a trigger message on each one or more sub-channels, to the wireless device, on a plurality of supported sub-channels. The method further comprises receiving a response message, from the wireless device, on any one or more of the one or more of the by the access point supported sub-channels, wherein which sub-channel to use for the response message is determined by the wireless device, and transmitting and/or receiving further messages to and/or from the wireless device, on the one or more sub-channels on which the response message was received.

By letting the wireless devices determine the sub-channel/s to use for further communication, favourable sub-channels can be selected for the different wireless devices.

According to some aspects, the response message is a random access message or a request for uplink resources and wherein the further messages comprise data traffic. As different STAs can be assumed to experience uncorrelated channels, the probability of two STAs selecting the same sub-channel is small (at least if using the methods for selection proposed above). Hence, the further messages will also have a high probability of being distributed over the entire bandwidth supported by the access point.

According to some aspects, the disclosure relates to a computer program comprising computer program code which, when executed in an access point, causes the access point to execute the methods described above and below.

According to some aspects, the disclosure relates to a wireless device configured to select one or more sub-channels for communication with an access point, wherein the one or more sub-channels is a subset of a plurality of sub-channels supported by the access point. The access point transmits replicas of a trigger message on the supported sub-channels. The trigger message indicates the start of a response window. The wireless device comprises a radio communication unit and processing circuitry. The radio communication unit is configured to communicate with an access point. The processing circuitry is configured to cause the wireless device to attempt to receive a replica of the trigger message, on one or more sub-channels of the plurality of sub-channels, repeating the attempt to receive a replica of the trigger message, until a trigger message that fulfils at least one predetermined criterion is received on one or more sub-channels. The processing circuitry is further configured to thereafter transmit, in the response window, using the radio communication unit, a response message, to the access point, on the one or more sub-channels on which the trigger message was received.

According to some aspects, the disclosure relates to an access point configured to communicate with a wireless device on one or more sub-channels. The access point comprises a radio communication unit and processing circuitry. The radio communication unit is configured to communicate with wireless devices. The processing circuitry is configured to cause the access point to transmit, using the radio communication unit, a replica of a trigger message on each one or more sub-channels, to the wireless device, on a plurality of supported sub-channels and to receive, using the radio communication unit, a response message, from the wireless device, on any one of the one or more of the by the access point supported sub-channels, wherein which sub-channel to use for the response message is determined by the wireless device. The access point is further configured to transmit and/or receive, using the radio communication unit, further messages to and/or from the wireless device, on the one or more sub-channel on which the response message was received.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 illustrates sub-channels supported by an access point and by a wireless device comprising a narrowband receiver.

FIG. 2 illustrates a wireless device going into sleep mode in between its attempts to receive a trigger message from an access point.

FIG. 3 illustrates examples of a system comprising an access point and multiple wireless devices.

FIG. 4 is a flow chart that illustrates the method steps performed in the wireless device according to an embodiment of the present disclosure.

FIG. 5 is a flow chart that illustrates the method steps performed in the access device according to an embodiment of the present disclosure.

FIG. 6 illustrates an exemplary sequence of messages exchanged between an access point and a wireless device.

FIG. 7 illustrates an exemplary wireless device according to an embodiment of the present disclosure.

FIG. 8 illustrates an exemplary access point according to an embodiment of the present disclosure.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

The disclosed method propose a simplified way for wireless devices 200 to select on which sub-channel/s they prefer to communicate with an access point 100, wherein the selection is made based on a trial-and-error algorithm, rather than on complete measurements over the available sub-channels.

To facilitate the understanding of the proposed technique the problem of channel allocation is now further discussed.

Access points 100 are generally configured to communicate on a rather wide bandwidth, i.e., many sub-channels. In order to determine which sub-channel or sub-band to utilize for communication with a specific wireless device 200 channel sounding is performed. This means that transmissions through all sub-channels are executed to estimate the quality of the channel, e.g. to estimate the amount of distortion and/or interference. In Wireless Local Area Network, WLAN, systems, the estimated quality of the channels is denoted Channel State Information, CSI, and it is obtained by the access point. For example, downlink channel estimates are obtained by an access point when it periodically or irregularly transmits pilot sounding sequences to the wireless devices. The wireless devices receive these sequences and estimate the channel. The channel estimates are then fed back as CSI from the wireless device to the access point. In Long Term Evolution, LTE, the so called Sounding Reference Signal, SRS, may be used for estimating the channel quality for different regions of a complete bandwidth. It is a reference signal transmitted by the UE, i.e., the wireless device, in the uplink direction and is used by the eNodeB, i.e., the access point, to estimate the uplink channel quality.

In contrast to access points 100, which often communicate on a rather wide bandwidth, wireless devices 200 e.g. Machine Type Communication devices, MTC devices, or Machine Devices, MDs, are sometimes configured to receive and transmit on one or a few sub-channels, i.e., on a narrow bandwidth frequency carrier, at the time, as discussed in the background. A wisely selected sub-channel can give better coverage and transmission than would be the case if the transmission would be over the entire bandwidth supported by the access point. The reason is that large parts of the entire bandwidth might be in deep fade or suffer from other transmission losses. If the wireless devices transmit on only one or a few sub-channels it opens up for other wireless devices to transmit their data simultaneously. That is, the spectrum is more efficiently used, compared to the case when the wireless devices transmit on the full bandwidth excluding the possibility that any other wireless device can use the full bandwidth at the same time.

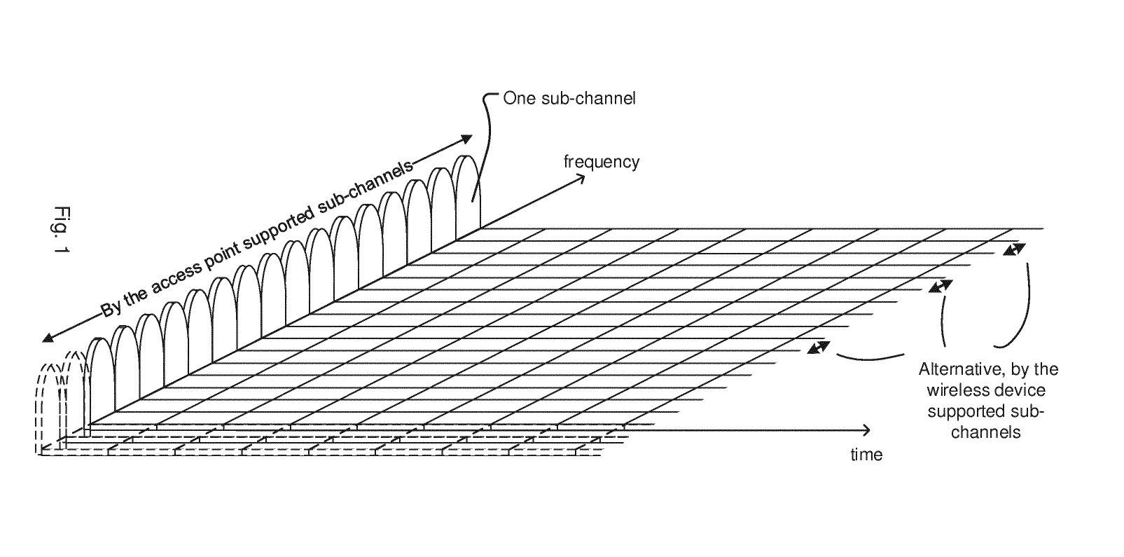

The frequency spectrum supported by the access point 100 and the wireless devices 200 are illustrated in FIG. 1. FIG. 1 shows an Orthogonal Frequency Division Multiplexing, OFDM scheme, where time versus frequency transmission is schematically depictured. The frequency band supported by the access point is divided into a plurality of sub-channels, i.e., different sets of sub-channels, each sub-channel comprising multiple sub-carriers. The MTC devices typically only support a sub-set of the frequency band supported by the access point. Hence, the MTC devices generally only communicate on a sub-channel of the entire frequency band supported by the access point. This disclosure relates to how to select this sub-channel.

For Machine Type Communication, MTC, devices, it is typically the case that the time between different transmissions is so long that the wireless devices 200 cannot stay synchronized to the access point 100 in a power efficient way. That is, in between the transmissions the wireless devices go back to deep sleep in order to save power, rather than on regular intervals wake up and listen to e.g. a beacon. This means that the access point 100 does now know which of the numerous wireless devices that that will wake up. Therefore, the access point cannot allocate the different wireless devices to different sub-channels. Another problem that would occur even if the access point would be able to schedule all the wireless devices is that a specific wireless device may be scheduled on a very poor sub-channel. As the bandwidth of the sub-channel is small, e.g. narrower than 2 MHz, the entire sub-channel may be in a deep fade. This might be the case when Long Range Low Power, LRLP, operating devices are present. Suppose that the system is uplink limited, e.g. due to that the LRLP wireless devices have a much lower output power than the access point. If the access point schedules a specific sub-channel to the wireless devices for it to send the uplink data or the Acknowledgement, ACK, signal then the wireless device might be allocated to a sub-channel with unfavorable conditions. Thus, even if the downlink packet is received by the wireless device, the ACK might not reach the access point. In the present disclosure relates to subject-matters where the abovementioned problematic situations are circumvented.

For a better understanding of the disclosure a short introduction to Orthogonal Frequency Division Multiplexing, OFDM, is given. Today most wireless standards use OFDM. OFDM is a method of encoding digital data on multiple carrier frequencies. That is, a large number of closely spaced orthogonal sub-carrier signals are used to carry data on several parallel data streams or sub-channels, c.f. FIG. 1. The reason that OFDM is preferred is mainly due to that it allows for relatively simple receiver processing for a wide bandwidth when the communication channel is frequency selective. OFDM also allows for a simple way to share the channels between different uses, i.e., wireless devices 200 by simply allocating different sets of sub-carriers, i.e., different sub-channels, to different users. This allocation is known as Orthogonal Frequency-Division Multiple Access, OFDMA. The set of sub-carriers allocated to different users may either be localized, i.e., the sub-carriers to one user are next to one another, or the set of sub-carriers may be distributed, i.e., the sub-carriers are spread out and interlaced with sub-carriers carrying data to other users.

To further ease the description, the description is made under the assumption that the system, i.e., the cellular network 300, is using parameters similar to the WLAN standard IEEE 802.11ax which discusses the upcoming Long Range Low Power, LRLP, standard. IEEE 802.11ax is the next generation of IEEE 802.11, which compared to previous versions, like IEEE 802.11n and IEEE 802.11ac, also supports OFDMA. That is, several wireless devices 200 can communicate with the access point 100 simultaneously utilizing different sub-channels. Moreover, trigger frames sent by the access point to the wireless devices are introduced in this standard. IEEE 802.11ax has also been designed to better handle outdoor environments as well as more densely populated areas compared to earlier versions which mainly have been concerned with the peak rate of a single link.

To exemplify, the disclosure is described for an OFDM Wireless Local Area Network, WLAN, system. The network node is referred to as the access point 100 and the user equipment as the Station, STA, or the wireless device 200. This is merely to ease the description, and is not to be seen as a limitation of the disclosure, since the proposed methods as such is applicable also to other standards and communication systems.

An example situation is also given to ease the understanding. It is assumed that the considered bandwidth supported by the access point 100 is 20 MHz and that the 20 MHz signal is generated by using a 256 point Fast Fourier Transform, FFT, where 240 sub-carriers are non-zero. The 16 (8+8) sub-carriers at the edges are set to zero to provide a guard band to the adjacent channels. It is assumed that the 240 sub-carriers are divided into 10 groups of equal size, i.e., 24 contiguous sub-carriers. A group of 24 sub-carriers is referred to as a sub-channel, corresponding to 1.875 MHz. The transmission from the access point to the wireless devices 200, i.e., the downlink, as well the transmission from the wireless devices to the access point, i.e., the uplink, may use any number of sub-channels in principle as decided by the access point. In LRLP, it is expected that the bandwidth to a wireless device may be about 2 MHz instead of 20 MHz, so essentially a sub-channel is allocated. Thus, thinking about LRLP, it may actually be so that a wireless device cannot receive over more than one sub-channel.

The described assumptions in previous paragraphs should not in any way be regarded as limiting to the scope of protection, since they are only made to facilitate a pedagogical explanation of the disclosure, i.e., the present disclosure may be utilized with parameters belonging to other standards, other frequency bandwidths and other sub-channel categorizations.

When the transmission is to, that is downlink, and from, that is uplink, more than one wireless device 200 or MD (in Wi-Fi generally referred to as STA), it is desirable that the allocation of sub-carriers are based on detailed knowledge of the channel conditions for the different wireless devices or MDs. This kind of allocating of the sub-carriers is commonly known as Frequency Selective Scheduling, FSS.

Although FSS potentially gives a performance gain, it requires that the access point 100 has knowledge of the channels to the different wireless devices 200. Such knowledge is typically obtained through channel sounding, i.e., the channels between the access point and the different wireless devices are measured as described previously for different systems. The access point then decides how to allocate sub-carriers to different users, based on the obtained measurements.

The channel knowledge at the access point 100 is needed both for downlink and uplink transmission, and when trying to optimize the gain that can be obtained by FSS, it is essential to keep the overhead related to obtaining the channel knowledge at the access point at a minimum. That is, one problem with the FSS is that it requires knowledge of the channels, and that the time required to obtain this knowledge reduces the gain that can be obtained during the actual data transmission. In particular, when the amount of data to be transmitted is small, the additional overhead required to obtain channel information at the access point makes FSS unfeasible. Moreover, in scenarios where the number of wireless devices 200 is large but where the activity for each individual wireless device is low, keeping track of the channel properties for all wireless devices using standard methods will be too ineffective.

One way to reduce the overhead related to obtaining the channel knowledge is to transfer the responsibility for selection of uplink communication sub-channel from the access point to the wireless device. For example, the US patent US2007097928 refers to a method where a mobile terminal selects an uplink transmission resource from a plurality of uplink transmission resources. The mobile terminal receives a downlink reference signal that has been transmitted over a range of frequencies, spanning a plurality of sub-ranges of frequencies representing uplink transmission resources. Moreover, comparison between and calculations using the received downlink reference signal and the known structure of the transmitted reference signal are performed for at least one of the sub-ranges of frequencies. These comparisons and calculations form the basis for the mobile terminal's selection of at least one of the sub-ranges of frequencies for uplink transmission.

Now returning to the OFDM scenario, one possible scenario is that a replica of a reference signal, in this disclosure referred to as a trigger message, is transmitted on each one of the sub-channels supported by the access point 100. One possibility would then be to let the wireless devices 200 perform measurements on the entire frequency band supported by the access point and let the wireless device select based on the measurements. Then the sub-channel with the best channel properties may be selected.

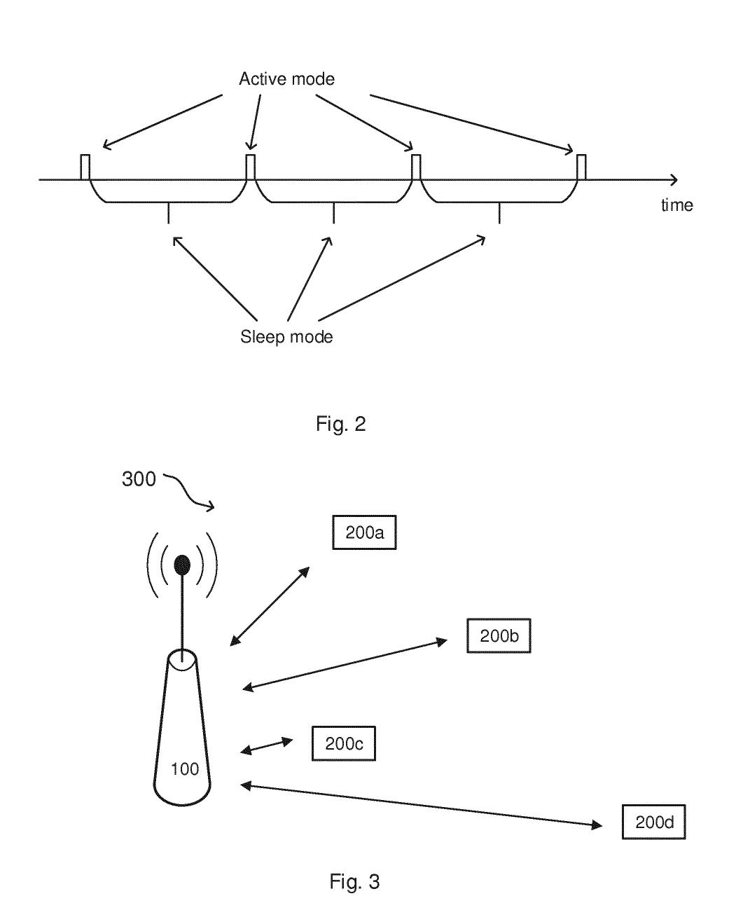

The present disclosure proposes a more simple solution, which is based on attempts to receive the trigger message. In the present disclosure, there is no need to measure and to calculate the quality of a large number of sub-channels at the time. Instead, the wireless device 200 tries to receive one or a few candidate sub-channel/s from the plurality of sub-channels supported by the access point 100. If the quality of the selected sub-channel is satisfactory a response message is transmitted to the access point on this specific sub-channel. However, if the quality of the sub-channel is dissatisfactory a new candidate sub-channel is selected in a trial-and-error manner until one with an adequate quality is found. If the selected sub-channel does not fulfil certain criteria the wireless device might enter into a sleep mode to save power, c.f. FIG. 2. After a while it goes back into active mode and tries again to receive a trigger message on another sub-channel. That is, in average, a fewer number of quality measures of sub-channels needs to be performed. Moreover, if there is a need for further communication, the access points continues to communicate with the wireless device on the sub-channel preferred by the wireless device. Having a distributed access system with further communication on the sub-channels selected by the wireless devices vouch for a utilization of the entire bandwidth. In e.g. a system with numerous wireless devices spread over a large area where the devices all might have different signal paths to the access point it is very likely that the different wireless devices prefer and select different sub-channels.

In other words, the disclosure presents a method for the access point 100 to obtain channel information without having to explicitly sounding the channel. Thus, the access point gets information about which is the best sub-channel or at least that a certain sub-channel is sufficiently good, simply by the fact that the access point receives a signal from the wireless device 200 on this sub-channel. At the same time, the access point also allows for a large number of wireless devices to perform random access. That is, instead of receiving the full downlink bandwidth supported by the access point, the wireless device selects one or a few sub-channels. Thus, the sub-channel access selection is distributed from the access point to the wireless devices. Many wireless devices may receive on different sub-channels, e.g. about 2 MHz sub-channels for LRLP operating devices, at the same time. This would mean that a signal downlink packet triggers many uplink packets. This might result in collisions. However, this does not have to be a drawback, since it is likely that the wireless devices are spread over a large area and those two wireless devices trying to transmit on the same sub-channel probably experience different sub-channel qualities due to different signal paths. This might for example be the case if one of the wireless devices is located much closer to the access point than the other one. The result being that one of the wireless devices transmits successfully to the access point, i.e., a success rate of 50%, instead of a success rate of 0% when both signals fail to reach the access point. This is referred to as the capture effect.

An exemplary situation where the method of the disclosure can be used is when a large number, typically more than 1000, of wireless devices 200 are associated to an access point 100. FIG. 3 schematically illustrates a cellular network 300 comprising a base station or an access point 100 and four wireless devices 200a-d, e.g. MDs or MTC devices. In a cell like the one disclosed in FIG. 3, wireless devices 200 are located at positions with different signal paths to the access point 100, i.e., the channel characteristics vary due to different reasons e.g. distance to access point 100, disturbing radio sources or obstacles such as buildings. The activity of each one of the wireless devices is very low, typically only a few packets per hour or less. The wireless devices can for instance be a large number of sensors or actuators in e.g. cars for communicating service needs, in water or electricity meters for remote control and/or remote meter reading, in street-side vending machines for communicating when enough coins are present to justify a visit for emptying, in ware houses for indication when goods are out-of-stock, in taxi cars for validating credit cards, in surveillance cameras for home or corporate security purposes, in containers in a transport system etc.

When one of the wireless devices 200 has something to send, e.g. sensor data, it wakes up from sleep and starts to attempt to receive a trigger message from the access point 100. Since the access point does not know when a specific wireless device is to wake up, it regularly or irregularly sends out trigger frames. More specifically, an identical trigger frame is sent on each one of the sub-channels supported by the access point, c.f. FIG. 1. The trigger frame indicates the start of a random access window for the wireless devices. The trigger frame may be used by the wireless devices to estimate the channel over the bandwidth used for the trigger frame. Moreover, the wireless device is free to select on which sub-channel/s its receiver should try to receive. Different candidates of choice are indicated in FIG. 1 with small arrows.

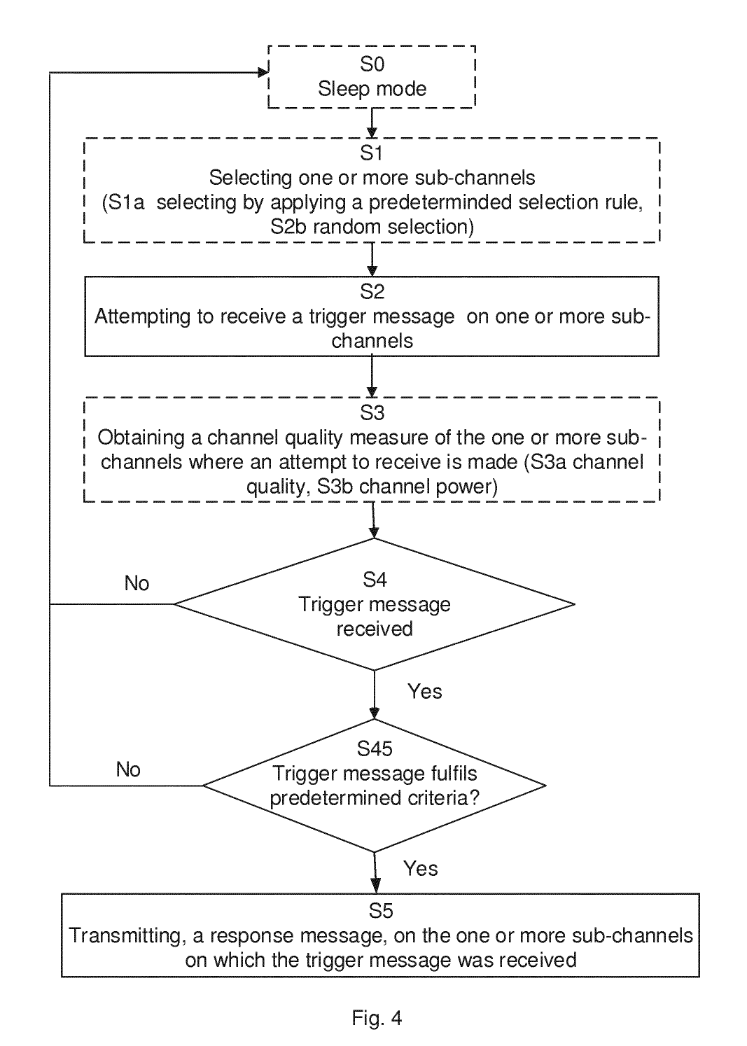

The proposed methods will now be described in more detail referring to FIGS. 4, 5 and 6. It should be appreciated that FIGS. 4, 5 and 6 comprise some operations and modules which are illustrated with a solid border and some operations and modules which are illustrated with a dashed border. The operations and modules which are illustrated with solid border are operations which are comprised in the broadest example embodiment. The operations and modules which are illustrated with dashed border are example embodiments which may be comprised in, or a part of, or are further embodiments which may be taken in addition to the operations and modules of the broader example embodiments. It should be appreciated that the operations do not need to be performed in order.

The proposed methods are performed in a network node, i.e. an access point, 100 and in wireless devices 200a-200d for selecting one or more sub-channels for communication with the access point. The methods will now be described in more detail referring to FIG. 4. It should be appreciated that the example operations of FIG. 4 may be performed simultaneously for any number of radio network nodes in the wireless communications network.

The methods are e.g. performed in the network 300 of FIG. 3, when one of the wireless devices 200 is about to transmit data to the access point 100. As described above the access point 100 transmits a trigger message over a full bandwidth. The wireless device is now about to receive the trigger message and thereafter one (or more) sub-channels is selected by the wireless device, using a method that will now be described.

The selected one or more sub-channels is a subset of a plurality of sub-channels supported by the access point 100. A sub-channel is a set of sub-carriers. A subset implies that one or more of the sub-channels are selected, but not all. A sub-channel comprises one or multiple sub-carriers. By performing the methods, a wireless device 200 selects which part of the available frequency band to use for responding to a trigger message and, according to some aspects of the disclosure, also for further communication. In one embodiment the sub-carriers in a sub-channel are contiguous, i.e., the sub-carriers are next to each other in frequency. In one embodiment the sub-carriers in a sub-channel are distributed, i.e., the sub-carriers are distributed in the frequency range and a sub-carrier's neighbors might belong to other sub-channels utilized by other wireless devices. In one aspect, the frequency bands of the selected sub-channels are not succeeding each other in the frequency range, i.e., other sub-channels might be interlaced in between.

The access point 100 transmits replicas of a trigger message on the supported sub-channels. In other words, the trigger message is transmitted over the full supported bandwidth. For example, one replica of the trigger message is transmitted on each sub-channel. So, the idea is that the access point does not indicate on which sub-channel the wireless devices 200 should receive and transmit. Instead, each wireless device selects one or more sub-channels with, for each specific wireless device, acceptable transmission properties out of the available sub-channels. For example, the access point 100 sends trigger frames that are spread out over the entire 20 MHz bandwidth, e.g. one copy of the trigger frame on each sub-channel. The trigger frame announces that wireless devices that have data to send should perform random access immediately after the trigger frame. The trigger frame may be sent periodically and the period may be defined based on latency requirements. The wireless devices that have data to send wake up and listen to the trigger frame. Hence, according to some aspect, the wireless device 200 is in a sleep mode, except when receiving and/or transmitting from the network node 100. The sleep mode is a power saving mode, wherein the wireless device does not perform radio activities. During the sleep period the wireless device 200 does not transmit or receive any packets and does not sense the channel states.

According to some aspects one or more tentative sub-channels are selected S1 by the wireless device 200. In other words, the access point 100 transmits a replica of the trigger message on all sub-channels. The wireless device 200 selects on which one or more sub-channels that it will try to receive the trigger message on. The wireless device may attempt to receive two or more trigger messages at a time or one single trigger message transmitted over two sub-channels.

Moreover, the method comprises the operation of attempting to receive S2 a replica of the trigger message on one or more sub-channels of the plurality of sub-channels. Hence, the wireless device 200 attempts to receive a trigger message on one (or more) subchannel at the time until reception is successful. Between attempts, the wireless device 200 may be timed-out by the sleep mode cycle, as explained more in detail below.

In other words, the wireless device 200 attempts to receive a radio signal on one or a few sub-channels and, based on the received signal, estimates for one or more predefined trigger messages a quality measure, e.g. signal-to-noise and interference levels. Such a quality measure can typically be based on a matched-filter approach where the received signal is correlated with each one of the one or more predefined synchronization sequences, e.g. random access preambles. If a match is found the trigger message is considered to be received.

The wireless device 200 may itself select on which sub-channel it should try to receive. According to some aspects at least one or more of the sub-channels, on which an attempt to receive S2 is made, is randomly selected S1b by the wireless device 200. If it can be assumed that the wireless devices experience uncorrelated channels, the probability of two wireless devices selecting the same sub-channel is as small as if the wireless devices would select the sub-channel in a completely random fashion. If the selected sub-channel is also used for further communications, as will be further discussed below, this method will also provide an even distribution of the wireless devices in the cell or service set over the supported frequency range.

According to some aspects at least one or more of the sub-channels, on which an attempt to receive S2 is made, is sequentially selected by the wireless device 200. In other words, in one embodiment the wireless device starts to attempt to receive on the sub-channel with the lowest frequencies, and if the attempt is unsuccessful a new attempt to receive is made on the sub-channel with the second lowest frequencies, and so on until the message is successfully received. In another embodiment the wireless device starts to attempt to receive on the sub-channel with the highest frequencies, and if the attempt is unsuccessful a new attempt to receive is made on the sub-channel with the second highest frequencies, and so on until the message is successfully received.

According to some aspects the at least one of the sub-channels on which an attempt to receive S2 is made, is selected S1a by applying a predetermined selection rule. For example, at the first attempt, it might be beneficial to use the last used channel. Another possibility is that some kind of algorithm is used. Preferably the wireless device 200 selects the last used sub-channel, but if it has experienced a high number of collisions, i.e., the random access has not been successful, it may also take this into account and select another sub-channel, suitably at same minimum distance in frequency from the unsuccessful attempt. Hence, random and predetermined selection may be used interchangeably.

The wireless device repeats the attempts S2, until a trigger message is correctly received. In other words, the method comprises repeating the attempt to receive S2 a replica of the trigger message, until a trigger message that fulfils at least one predetermined criterion S45 is received S4 on one or more sub-channels. Hence, the wireless device performs the attempts until a trigger message is received and accepted. The trigger message is considered accepted when the message, or the channel on which is received, fulfils the predetermined criterion. The predetermined criterion might be that the trigger message is simply detected and/or correctly decoded, but more advanced criteria are also possible. It may also be several criteria that need to be fulfilled. In other words, the wireless device 200 checks S45 if the received trigger message, or the channel on which it is transmitted, fulfils predetermined criteria and repeats the attempt until an acceptable trigger message is received or in other words until a match is found, i.e., until the correlation is above a certain threshold and the possible additional predetermined criteria are fulfilled.

The wireless device 200 may enter sleep mode between the attempts to receive. Alternatively, the attempts S2 are made in a consecutive sequence, i.e. without breaks for sleep. The sleep mode is a mode, wherein the wireless device performs radio transmissions less frequently than in an active mode. The wireless device 200 alternates between sleep mode and active in mode a repetitive cycle. In the sleep mode less power is consumed. Thus, according to some aspects the method comprises the step of entering S0, between the attempts to receive S2, a sleep mode, which is a mode during which the wireless device 200 is neither transmitting nor receiving. That is, in one aspect each time the wireless device, e.g. the sensor or actuator, wakes up, it makes one or more attempts to receive a trigger message on one sub-channel.

The sleep mode cycle or period may depend on when the trigger messages are transmitted. In one embodiment, the trigger message, e.g. a beacon signal, is transmitted every 100 ms which allows the wireless to sleep for 98 ms. Trigger frames are e.g. sent every 100 ms or once every 1 s. A durational trigger frame would be sent every 1 ms. Switching the frequency by a PLL takes generally 100 ms, but it could be done faster.

Alternatively the sleep cycle is dependent on the wireless device. For example the sleep cycle is dependent on the sensor or actuator, such that each time the wireless device wakes up to perform measurements; it also performs attempts to receive the trigger message.

The trigger message indicates the start of a response window. In other words, the trigger message indicates a point in time, when the wireless device is allowed to transmit or may be heard by the access point 100. The trigger message is e.g. a beacon signal but it may also be a downlink, DL, data packet which includes the information necessary for triggering the uplink random access. Specifically, at least a part of the DL data packet is repeated over the different sub-channels, although another part of the DL data packet may not be repeated. Alternatively, the wireless device may request the trigger message and the access point sends a response including the trigger message upon the reception of the request. A similar trigger message has already been discussed in the WLAN standardization. The 802.11ax standard has indicated to include two mechanisms to send the trigger message in a form of Target Wake Time, TWT, i.e. broadcast triggered TWT in the Beacon and solicited triggered TWT using a TWT negotiation procedure.

After the successful reception, the wireless device 200 transmits S5 a response message to the access point 100, in the response window, on the one or more sub-channels on which the trigger message was received. In other words, the wireless device sends a response, e.g. a random access message, to the trigger message, on the sub-channel, which the wireless device determined S45 to be acceptable or favorable. When the access point receives the random access message, it therefore knows on what part of the frequency band to schedule that particular wireless device. Hence, by transmitting a response message the wireless device has implicitly selected one or more sub-channels for communication.

That is, disclosure is applicable to uplink data transmission, in which case the random access message sent by the wireless device may either contain the data directly, or it will implicitly indicate on what part of the band it should be scheduled. Moreover, the response window is a random access window or a scheduled transmission window. That is, the response window is the time slot when the access point listens to or is able to receive signals from the wireless devices. According to some aspects the response message is an Acknowledgement, ACK, signal.

According to some aspects the method comprises obtaining S3 a channel quality measure of the one or more sub-channels where an attempt to receive is made. A first example is obtaining S3a a channel quality measure of the one or more sub-channels where an attempt to receive S2 is made. Then the trigger message is considered to fulfil the predetermined criterion S45 if the channel quality fulfils a predetermined criterion. In one embodiment the criterion is that a message is received. In other words, if the estimation of the channel quality of the selected sub channel results in a satisfactory result, i.e., if certain criteria or criterion are fulfilled, then the sub-channel/s is selected for further communication. However, if the condition of the channel/s does not fulfill predetermined criteria, the wireless device 200 can enter sleep mode to save power. After a while it goes back into active mode and tries again to receive a trigger message on another sub-channel, c.f. FIG. 2. This is repeated until a sub-channel fulfilling the predetermined criteria/on is found. Furthermore, the channel quality measure is e.g. a signal-to-noise measure. The criterion is e.g. that a quality measure is above a certain level.

According to some aspects of the disclosure the method comprises obtaining S3b a channel power measure of the one or more sub-channels where an attempt to receive S2 is made. Then the trigger message is considered to fulfil the predetermined criterion S45 if the channel power fulfils a predetermined criterion. On example is that the channel power is above and/or equal to a certain level. Several criteria based on e.g. different quality and power measures may be needed in combination for the trigger message to be considered received.

The trigger message may also comprise information, such as transmission power of the access point 100 used for transmitting the trigger message. According to some aspects the received trigger message comprises a transmission power level of the access point 100 and wherein the predetermined criterion comprises the received transmission power level. In other words the path loss between the transmitter and the receiver may be considered, when determining whether the trigger message is received or not or rather if a certain sub-channel should be selected. In one embodiment the wireless devices 200 are low power devices, i.e., they transmit with a substantially lower power than the access point. Moreover, the wireless devices are able to determine the signal level, i.e., the power, of a received message, and to compare it with the power of the transmitted signal level. This transmission power is utilized to decide whether the quality of the sub-channel is sufficient. That is, if the power of the received signal is too low, a transmitted message from the wireless device will not reach the access point since the wireless device has a lower transmission power. Thus, the sub-channel is rejected since it does not fulfil the predetermined criterion regarding the power level, even though a message was successfully received on the specific sub-channel. In one embodiment the wireless devices transmits with 20 dB lower power level compared to that of the access point.

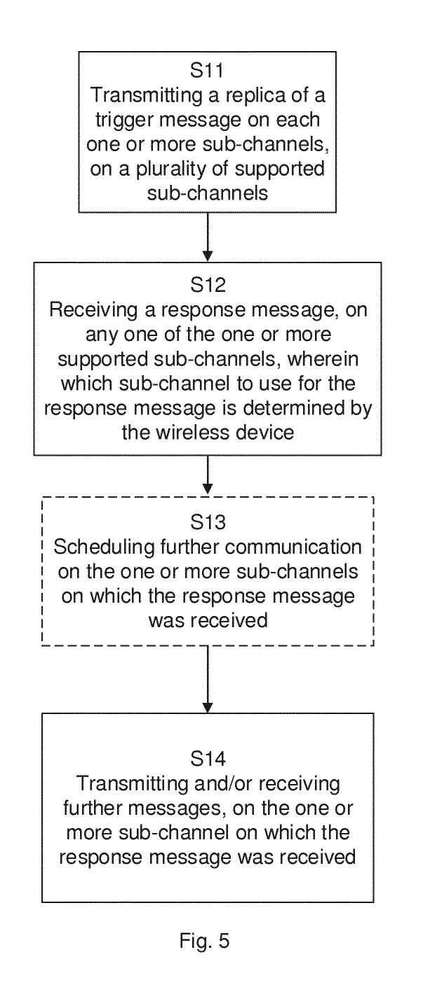

The corresponding method in an access point 100 will now be described in more detail referring to FIG. 5. It should be appreciated that the example operations of FIG. 5 may be performed simultaneously for any number of radio network nodes in the wireless communications network.

FIG. 5 illustrates a method, performed in an access point 100 of communicating with a wireless 200 device on one or more sub-channels. The method comprises transmitting S11 a replica of a trigger message on each one or more sub-channels, to the wireless device 200, on a plurality of supported sub-channels. The trigger message indicates when and on what sub-channels the wireless devices are allowed to transmit. It may also be that the trigger message indicates resources where the wireless devices may be heard. For example the trigger messages indicate a response window, such as a Random Access window.

The method further comprises receiving S12 a response message, from the wireless device 200, on any one or more of the one or more of the by the access point 100 supported sub-channels, wherein which sub-channel to use for the response message is determined by the wireless device 200. In other words, the access point sends the trigger message on all available sub-channels and lets the wireless devices select, which sub-channel to use. In one embodiment the response message contains data, e.g. sensor data, from the wireless device. In another embodiment the response message indicates on which sub-channel the wireless device wants to be scheduled in order to provide for satisfying signal transmission. That is, according to some aspects, the response message is a random access message or a request for uplink resources. That is, according to some aspects, the scheduling in the downlink is based on what uplink sub-channel was used for random access.

It can be noted that, this may result in that two wireless devices 200 selects the same sub-channel which potentially will result in a collision. Note that a collision, in the sense that none of the transmissions is successful, does only occur if the signals received from the wireless devices selecting the same sub-channel are reasonably close in power, e.g. within 5 dB. If one of the signals is much stronger this one will likely be correctly received, whereas the weaker ones will not. This is commonly referred to as the capture effect.

According to some aspects, the method further comprises scheduling S13 further communication with the wireless device 200, on the one or more sub-channels on which the response message was received. In other words, the disclosure is applicable for the downlink, in that the access point 100 schedules the downlink on the same sub-channel as it received the random access request. Moreover, further communication typically comprises data traffic. In radio systems like Wireless Local Area Network, WLAN, and Long Term Evolution, LTE, the scheduling of resources is typically performed by the access point. When an access point receives a request for resources from a wireless device, it schedules resources and uses control signaling to inform the wireless device about which resources to use.

Finally the method comprises transmitting and/or receiving S14 further messages to and/or from the wireless device 200, on the one or more sub-channels on which the response message was received. The further transmission may be uplink or downlink. For the uplink it is envisioned that in many situations, the wireless device has very little data to send, and in this case the actual data is also contained in the response to the trigger message, e.g. in a random access message. In case the amount of data is too large to be included in a single message, this will be signaled in the random access message, and then the access point 100 can schedule the wireless device on the same sub-channel as was used for the random access message.

A downlink scenario will now be described. In this example, the intention with the proposed methods is to transmit data in the downlink to several wireless devices using e.g. OFDMA. Specifically, the intention is to do this in a way such that favorable sub-channels are allocated to the different wireless devices 200. According to the proposed method, this is achieved by that the access point 100 sends a trigger frame, informing about to what wireless devices it has data. Rather than allocating specific sub-channels for the different wireless devices to respond on, the addressed wireless devices reply on the most favorable sub-channel. Upon receiving the responses, the access point 100 performs the actual downlink transmissions.

For the downlink the capture effect has the nice property that it is possible to request more wireless devices 200 to respond than there are sub-channels. Clearly some of the wireless devices signals will not be correctly received. However, the probability of getting at least some is higher than in case when all signals would be received with the same power.

Thus, the access point 100 may take advantage of the capture effect by determine the number of wireless devices 200 to address in a trigger frame at least in part based on the expected power distribution of the signals of the different wireless devices.

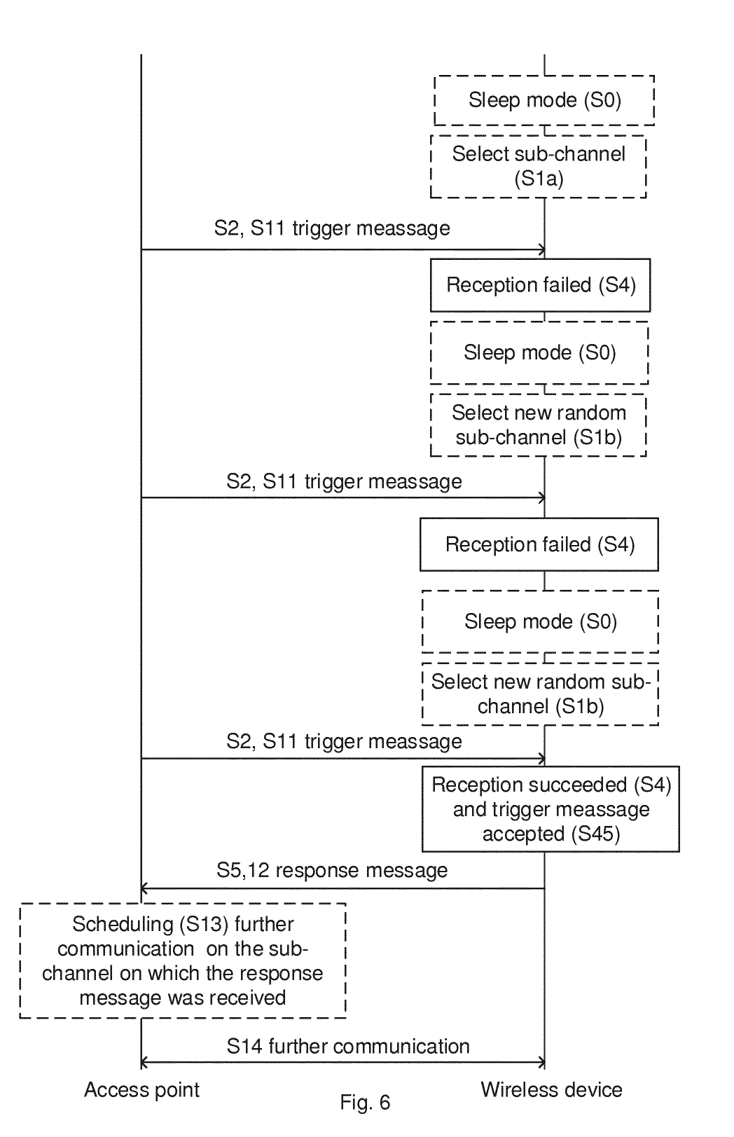

FIG. 6 is an exemplary time flow scheme further illustrating the operations described in FIGS. 4 and 5. FIG. 6 depicts an aspect of how the operations of the method as well as the signaling between an access point 100 and a wireless device 200 is executed in time.

### Example Node Configuration

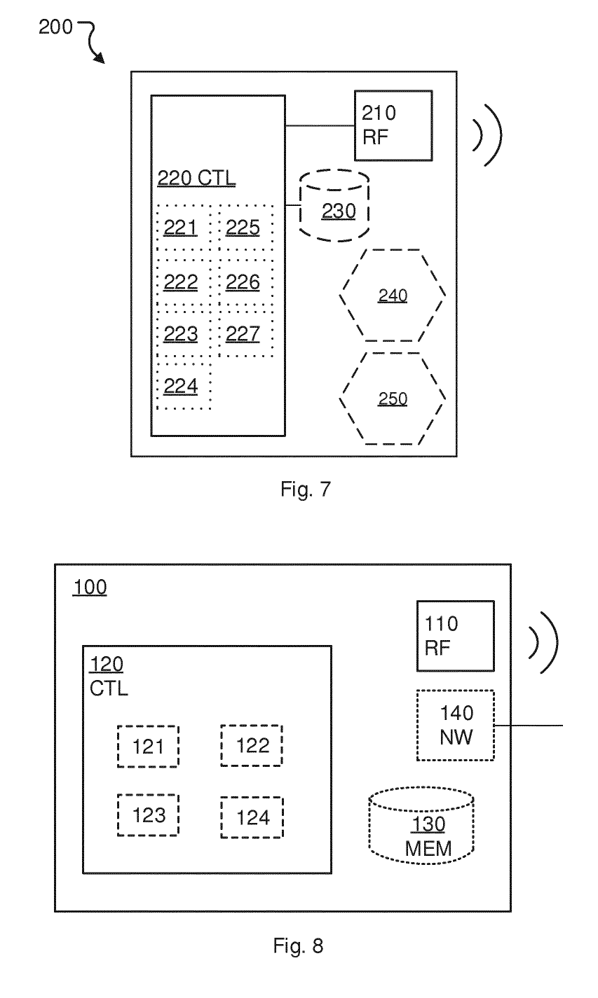

FIG. 7 illustrates an example wireless device 200, according to some of the example embodiments, wherein the wireless device is configured to select one or more sub-channels for communication with an access point 100, wherein the one or more sub-channels is a subset of a plurality of sub-channels supported by the access point and wherein the access point 100 transmits replicas of a trigger message on the supported sub-channels and wherein the trigger message indicates the start of a response window.

Within the context of this disclosure, the terms “wireless terminal” or “wireless device” encompass any device which is able to communicate wirelessly with another device, as well as, optionally, with an access node of a wireless network, by transmitting and/or receiving wireless signals. Thus, the term “wireless device” encompasses, but is not limited to: a user equipment, e.g. an LTE UE, a mobile terminal, a stationary or mobile wireless device for machine-to-machine communication, a Machine Type Communication, MTC, device, a Machine Device, MD, an integrated or embedded wireless card, an externally plugged in wireless card, a dongle etc. Throughout this disclosure, the term “wireless device” is sometimes used to exemplify various embodiments. However, this should not be construed as limiting, as the concepts illustrated herein are equally applicable to all kinds of other wireless devices. Hence, whenever a “wireless device” is referred to in this disclosure, this should be understood as encompassing any wireless device as defined above.

In one embodiment the wireless device 200 comprises a narrowband transmitter, wherein the supported bandwidth of the narrowband transmitter is less than the total bandwidth of the sub-channels supported by the access point 100. In other words, the wireless device might be able to attempt to receive on a wide bandwidth, i.e., a multiple of sub-channels, whereas the transmission is performed on one or a few sub-channels.

As shown in FIG. 7, the wireless device 200 according to some aspects comprise a radio communication interface 210 configured to receive and transmit any form of communications or control signals within a network. It should be appreciated that the radio communication interface 210 may be comprised as any number of transceiving, receiving, and/or transmitting units or circuitry. It should further be appreciated that the radio communication interface 210 may be in the form of any input/output communications port known in the art. The radio communication interface 210 may comprise RF circuitry and baseband processing circuitry (not shown).

According to some aspects, the wireless device 200 comprises a narrowband receiver, wherein the supported bandwidth of the narrowband receiver is less than the total bandwidth of the sub-channels supported by the access point 100. Furthermore, the embodiments with a narrowband receiver and a narrowband transmitter can of course be comprised in the same embodiment.

The wireless device 200 may further comprise at least one memory unit or circuitry 230 that may be in communication with the radio communication interface 210. The memory 230 may be configured to store received or transmitted data and/or executable program instructions. The memory 230 may also be configured to store any form of beam-forming information, reference signals, and/or feedback data or information. The memory 230 may be any suitable type of computer readable memory and may be of volatile and/or non-volatile type. According to some aspects, the disclosure relates to a computer program comprising computer program code which, when executed in a wireless device, causes the wireless device to execute any aspect of the described example node operations.

The wireless device 200 may further comprise processing circuitry 220 which may be configured to cause the wireless device 200 to, on one or more sub-channels of the plurality of sub-channels, attempt to receive a replica of the trigger message, and to repeat the attempt to receive a replica of the trigger message, until a trigger message that fulfils at least one predetermined criterion is received on one or more sub-channels. The processing circuitry 220 may further be configured to thereafter cause the wireless device 200 to transmit, in the response window, using the radio communication unit 210, a response message, to the access point 100, on the one or more sub-channels on which the trigger message was received.

According to some aspects, the wireless device 200 is configured to cause the wireless device to enter a sleep mode, between the attempts to receive, wherein the sleep mode is a mode during which the wireless device is neither transmitting nor receiving.

The processing circuitry 220 may be any suitable type of computation unit, e.g. a microprocessor, digital signal processor, DSP, field programmable gate array, FPGA, or application specific integrated circuit, ASIC, or any other form of circuitry. It should be appreciated that the processing circuitry need not be provided as a single unit but may be provided as any number of units or circuitry.

According to some aspects the processing circuitry also comprises at least a sensor or sensor module 240 configured to e.g. detect, measure and/or record facts, conditions etc. Examples of conditions are for instance temperature or pressure.

According to some aspects the processing circuitry also comprises at least an actuator 250 configured for moving or controlling a mechanisms or systems. One example is for instance change of temperature.

The sensors 240 and actuators 250 are configured to communicate with the processing circuitry as well as with application servers for the purpose of configuration of and data receipt from said autonomous devices within or outside the cellular network.

According to some aspects the processing circuitry 220 comprises modules configured to perform the methods described above. The modules are implemented in hardware or in software or in a combination thereof. The modules are according to one aspect implemented as a computer program stored in a memory 230 which run on the processing circuitry 220.

Hence, according to some aspects, the processing circuitry 220 comprises a receiver module 221 configured to cause the wireless device 200 to attempt to receive, on one or more sub-channels of the plurality of sub-channels, a replica of the trigger message, until a trigger message that fulfils predetermined at least one predetermined criterion is received.

The processing circuitry 220 further comprises a transmitter module 222 configured to after successful reception of a trigger message cause the wireless device 200 to transmit, in the response window, using the radio communication unit 210, a response message, to the access point 100, on the one or more sub-channels on which the trigger message was received.

According to some aspects the processing circuitry 220 comprises a selection module 224 configured to cause the wireless device 200 to select one or more sub-channels of the plurality of sub-channels. In one embodiment the selection module 224 is configured to select by applying a predetermined selection rule. In another embodiment the selection module 224 is configured to randomly select the one or more sub-channels.

According to some aspects the processing circuitry 220 comprises a quality measure obtaining module 225 configured to cause the wireless device 200 to obtain a channel quality measure of the one or more sub-channels where an attempt to receive is made by the circuitry in the receiving module 221. In one embodiment the quality measure obtaining module 225 is configured to obtain a channel quality measure of the one or more sub-channels where an attempt to receive is made by the circuitry in the receiving module 221. In another embodiment the quality measure obtaining module 225 is configured to obtain a channel power measure of the one or more sub-channels where an attempt to receive is made by the circuitry in the receiving module 221.

According to some aspects the processing circuitry 220 comprises a determination module 226 configured to determine if the sub-channel on which the trigger message is attempted to be received on by the receiving module 221 fulfils predetermined criteria, as discussed above.

According to some aspects the processing circuitry 220 also comprises a sleep module 227 configured to cause the wireless device to enter a sleep mode, between the attempts to receive, wherein the sleep mode is a mode during which the wireless device is neither transmitting nor receiving.

FIG. 8 illustrates an example access point 100, configured to communicate with a wireless device 200 on one or more sub-channels. The access point, in this application also referred to as network node or base station is typically a radio network node or access point such as an access point in IEEE 802.11.

A cell or Basic Service Set, BSS, is associated with a radio node, where a radio node or radio network node or eNodeB used interchangeably in the example embodiment description, comprises in a general sense any node transmitting radio signals, e.g., eNodeB, macro/micro/pico base station, home eNodeB, relay, discovery signal device, access node/point, or repeater. A radio network node herein may comprise a radio network node operating in one or more frequencies or frequency bands. It may be a radio network node capable of the network infrastructure management software CA. It may also be a single- or multi-Radio Access Technology, RAT, node. A multi-RAT node may comprise a node with co-located RATs or supporting multi-standard radio, MSR or a mixed radio network node.

The access point 100 comprises radio communication interface 110, a network communication interface 140 and processing circuitry 120.

The radio communication interface 110 is configured for communication with wireless devices 200 within reach of the access point 100 over a radio communication technology such as WLAN technology.

The network communication interface 140 is configured for communication with other access points 100 or network nodes. This communication is often wired e.g. using fiber. However, it may as well be wireless. The connection between access points is generally referred to as the backhaul.

The controller, CTL, or processing circuitry 120 may be constituted by any suitable type of computation unit, e.g. a microprocessor, Central Processing Unit, CPU, microcontroller, Digital Signal Processor, DSP, field programmable gate array, FPGA, or application specific integrated circuit, ASIC, or any other form of circuitry capable of executing computer program code. The computer program may be stored in a memory, MEM 130. The memory 130 can be any combination of a Read And write Memory, RAM, and a Read Only Memory, ROM. The memory 130 may also comprise persistent storage, which, for example, can be any single one or combination of magnetic memory, optical memory, or solid state memory or even remotely mounted memory. It should be appreciated that the processing circuitry need not be provided as a single unit but may be provided as any number of units or circuitry.

According to some aspects, the disclosure relates to a computer program comprising computer program code which, when executed, causes an access point 100 to execute the methods described above and below.

The processing circuitry 120 is configured to perform the proposed methods. Hence, the processing circuitry 120 is configured to cause the access point 100 to transmit, using the radio communication unit 110, a replica of a trigger message on each one or more sub-channels, to the wireless device 200, on a plurality of supported sub-channels and to receive S12, using the radio communication unit 110, a response message, from the wireless device 200, on any one of the one or more of the by the access point 100 supported sub-channels, wherein which sub-channel to use for the response message is determined by the wireless device 200.

According to some aspects, the processing circuitry 120 is configured to schedule further communication with the wireless device 200, on the one or more sub-channels on which the response message was received.

The processing circuitry 120 is further configured to transmit and/or receive, using the radio communication unit 110, further messages to and/or from the wireless device 200, on the one or more sub-channel on which the response message was received.

According to some aspects the processing circuitry 120 comprises modules configured to perform the methods described above. The modules are implemented in hardware or in software or in a combination thereof. The modules are according to one aspect implemented as a computer program stored in a memory 130 which run on the processing circuitry 120.

Hence, according to some aspects, the processing circuitry 120 comprises a transmitter module 121 configured to cause the access point 100 to transmit, using the radio communication unit 110, a replica of a trigger message on each one or more sub-channels, to the wireless device 200, on a plurality of supported sub-channels.

The processing circuitry 120 further comprises a receiver module 122 configured to cause the access point 100 to receive S12, using the radio communication unit 110, a response message, from the wireless device 200, on any one of the one or more of the by the access point 100 supported sub-channels, wherein which sub-channel to use for the response message is determined by the wireless device 200.

According to some aspects the processing circuitry also comprises a scheduler 123 configured to cause the access point 100 to schedule further communication with the wireless device 200, on the one or more sub-channels on which the response message was received.

The processing circuitry 120 further comprises a communication module 124 configured to cause the access point 100 to transmit and/or receive, using the radio communication unit 110, further messages to and/or from the wireless device 200, on the one or more sub-channels on which the response message was received.

Aspects of the disclosure are described with reference to the drawings, e.g., block diagrams and/or flowcharts. It is understood that several entities in the drawings, e.g., blocks of the block diagrams, and also combinations of entities in the drawings, can be implemented by computer program instructions, which instructions can be stored in a computer-readable memory, and also loaded onto a computer or other programmable data processing apparatus. Such computer program instructions can be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved. Also, the functions or steps noted in the blocks can according to some aspects of the disclosure be executed continuously in a loop.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

The various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that performs particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

1. A method performed in a wireless device for selecting one or more sub-channels for communication with an access point, wherein the one or more sub-channels is a subset of a plurality of sub-channels supported by the access point, and wherein the access point transmits replicas of a trigger message on the supported sub-channels, the trigger message indicating the start of a response window, the method comprising:
on one or more sub-channels of the plurality of sub-channels, attempting to receive a replica of the trigger message;
repeating the attempt to receive a replica of the trigger message, until a trigger message that fulfils at least one predetermined criterion is received on one or more sub-channels; and thereafter; and
transmitting a response message to the access point in the response window, on the one or more sub-channels on which the trigger message was received.

2. The method according to claim 1, comprising:
entering between the attempts to receive, a sleep mode, which is a mode during which the wireless device is neither transmitting nor receiving.

3. The method according to claim 1, comprising:
obtaining a channel quality measure of the one or more sub-channels where an attempt to receive is made, and
wherein the trigger message is considered to fulfil the predetermined criterion if the channel quality fulfils a predetermined criterion.

4. The method according to claim 3, wherein the channel quality measure comprises a signal-to-noise measure.

5. The method according to claim 1, comprising:
obtaining a channel power measure of the one or more sub-channels where an attempt to receive is made, and
wherein the trigger message is considered to fulfil the predetermined criterion if the channel power fulfils a predetermined criterion.

6. The method according to claim 1, wherein the received trigger message comprises a transmission power level of the access point and wherein the predetermined criterion comprises the received transmission power level.

7. The method according to claim 1, wherein at least one or more of the sub-channels, on which an attempt to receive is made, is randomly selected by the wireless device.

8. The method according to claim 1, wherein at least one of the sub-channels on which an attempt to receive is made, is selected by applying a predetermined selection rule.

9. The method according to claim 1, wherein the response window is a random access window or a scheduled transmission window.

10. A non-transitory computer readable storage medium comprising computer program code which, when executed in a wireless device, causes the wireless device to execute a method for selecting one or more sub-channels for communication with an access point, wherein the one or more sub-channels is a subset of a plurality of sub-channels supported by the access point, and wherein the access point transmits replicas of a trigger message on the supported sub-channels, the trigger message indicating the start of a response window, the method comprising:
on one or more sub-channels of the plurality of sub-channels, attempting to receive a replica of the trigger message;
repeating the attempt to receive a replica of the trigger message, until a trigger message that fulfils at least one predetermined criterion is received on one or more sub-channels; and thereafter; and
transmitting a response message to the access point in the response window, on the one or more sub-channels on which the trigger message was received.

11. A wireless device configured to select one or more sub-channels for communication with an access point, wherein the one or more sub-channels is a subset of a plurality of sub-channels supported by the access point and wherein the access point transmits replicas of a trigger message on the supported sub-channels, the trigger message indicating the start of a response window, the wireless device comprising:
a radio communication unit configured to communicate with an access point,
processing circuitry configured to cause the wireless device:
to, on one or more sub-channels of the plurality of sub-channels, attempt to receive a replica of the trigger message,
to repeat the attempts to receive a replica of the trigger message, until a trigger message that fulfils at least one predetermined criterion is received on one or more sub-channels; and to thereafter;
to transmit, in the response window, using the radio communication unit, a response message, to the access point, on the one or more sub-channels on which the trigger message was received.

12. The wireless device according to claim 10, wherein the processing circuitry is configured:
to cause the wireless device to enter a sleep mode, between the attempts to receive, wherein the sleep mode is a mode during which the wireless device is neither transmitting nor receiving.

13. The wireless device according to claim 10, wherein the wireless device comprises a narrowband receiver, wherein the supported bandwidth of the narrowband receiver is less than the total bandwidth of the sub-channels supported by the access point.

14. A method, performed in an access point, for communicating with a wireless device on one or more sub-channels, the method comprising:
transmitting a replica of a trigger message on each one or more sub-channels, to the wireless device, on a plurality of supported sub-channels,
receiving a response message, from the wireless device, on any one or more of the one or more of the by the access point supported sub-channels, wherein which sub-channel to use for the response message is determined by the wireless device, and
transmitting and/or receiving further messages to and/or from the wireless device, on the one or more sub-channels on which the response message was received.

15. The method according to claim 14, wherein the response message is a random access message or a request for uplink resources and wherein the further messages comprise data traffic.

16. The method according to claim 14, comprising:
scheduling further communication with the wireless device, on the one or more sub-channels on which the response message was received.

17. A non-transitory computer readable medium comprising computer program code which, when executed in an access point, causes the access point to execute a method for communicating with a wireless device on one or more sub-channels, the method comprising:
transmitting a replica of a trigger message on each one or more sub-channels, to the wireless device, on a plurality of supported sub-channels;
receiving a response message, from the wireless device, on any one or more of the one or more of the by the access point supported sub-channels, wherein which sub-channel to use for the response message is determined by the wireless device; and
transmitting and/or receiving further messages to and/or from the wireless device, on the one or more sub-channels on which the response message was received.

18. An access point configured to communicate with a wireless device on one or more sub-channels comprising:
a radio communication unit to communicate with wireless devices,
processing circuitry configured to cause the access point:
to transmit, using the radio communication unit, a replica of a trigger message on each one or more sub-channels, to the wireless device, on a plurality of supported sub-channels,
to receive, using the radio communication unit, a response message, from the wireless device, on any one of the one or more of the by the access point supported sub-channels, wherein which sub-channel to use for the response message is determined by the wireless device, and
to transmit and/or receive, using the radio communication unit, further messages to and/or from the wireless device, on the one or more sub-channel on which the response message was received.

19. An access point according to claim 18, wherein the processing circuitry is configured to schedule further communication with the wireless device, on the one or more sub-channels on which the response message was received.
